(19) United States
(12) Patent Application Publication
(10) Pub. No.: US 2025/0157213 A1
(43) Pub. Date: May 15, 2025

(54) METHOD AND APPARATUS WITH IMAGE-QUALITY ASSESSMENT

(71) Applicants: Samsung Electronics Co., Ltd., Suwon-si (KR); UIF (University Industry Foundation), Yonsei University, Seoul (KR)

(72) Inventors: Sehwan KI, Suwon-si (KR); Daekyu KWON, Seoul (KR); Dongyoung KIM, Seoul (KR); Seon Joo KIM, Seoul (KR); Younghyun JO, Suwon-si (KR); Hyong Euk LEE, Suwon-si (KR)

(73) Assignees: Samsung Electronics Co., Ltd., Suwon-si (KR); UIF (University Industry Foundation), Yonsei University, Seoul (KR)

(21) Appl. No.: 18/947,679

(22) Filed: Nov. 14, 2024

(30) Foreign Application Priority Data
Nov. 14, 2023 (KR) 10-2023-0157716

(51) Int. Cl. G06V 10/98; G06V 10/82

(52) U.S. Cl. CPC G06V 10/993; G06V 10/82

(57) ABSTRACT

A method and apparatus for image quality assessment are provided. The method of image quality assessment includes: accessing a text prompt representing an image-quality attribute of a target image included in a data set; training a target encoder to correspond to a visual-language model (VLM), the training based on data obtained by applying the text prompt to the VLM; and fine-tuning the trained target encoder to perform image-quality assessment.

### CROSS-REFERENCE TO RELATED APPLICATIONS

This application claims the benefit under 35 USC § 119 (a) of Korean Patent Application No. 10-2023-0157716, filed on Nov. 14, 2023, in the Korean Intellectual Property Office, the entire disclosure of which is incorporated herein by reference for all purposes.

### BACKGROUND

### 1. Field

The following embodiments relate to a method and apparatus with image-quality assessment.

### 2. Description of Related Art

Due to the development of deep learning, studies have been conducted to explore the idea of a neural network learning, on its own, a representation suitable for a task, when the data and the task are given. Furthermore, in the field of image quality assessment (IQA), a learning method using deep learning has been studied. However, in the IQA field, because the number of data sets is usually small, unlike with typical computer vision tasks such as classification and super resolution, the performance of a neural network configured for IQA may not be significantly improved.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method, performed by one or more processors, of image-quality assessment, includes: accessing a text prompt representing an image-quality attribute of a target image included in a data set; training a target encoder to correspond to a visual-language model (VLM), the training based on data obtained by applying the text prompt to the VLM; and fine-tuning the trained target encoder to perform image-quality assessment.

The method may further include determining the text prompt by: analyzing correlations between words related to the target image and image quality of the target image; and based on a result of analyzing the correlation, selecting the text prompt corresponding to an image-quality attribute of the target image.

The analyzing of the correlation may include: selecting the words related to image-quality degradation of the target image; generating degraded images by applying, to the target image, with varying intensities, an effect of the image-quality degradation corresponding to the words; calculating similarities between the degraded images and the words; and analyzing correlations between the similarities and the intensities of image-quality degradation effect.

The selecting of the words may include selecting the words including first texts of a positive attribute related to image-quality degradation of the target image using a large language model (LLM) or second texts of a negative attribute related to the image-quality degradation.

The determining of the text prompt may include selecting, from the words, an antonym word-pair having a highest correlation to be in the text prompt, the selecting based on the result of analyzing the correlations.

The VLM may include: an image encoder configured to encode the target image as an image feature vector of an embedding space shared between the target image and the text prompt; and a text encoder configured to encode the text prompt as a text feature vector of the embedding space.

The training of the target encoder may include generating the data showing degrees of correlations corresponding to image-quality attributes of the target image by comparing correlations between the text prompt and an image-quality attribute of the target image.

The generating of the data may include: obtaining image feature vectors by projecting the target image onto the embedding space by using an image encoder of the VLM; obtaining text feature vectors by projecting the text prompt onto the embedding space by using a text encoder of the VLM; and generating the data based on a similarity comparison between the text feature vectors and the image feature vectors.

The text feature vectors may be obtained by projecting, onto the embedding space, an antonym pair of a positive attribute related to the image quality and a negative attribute related to the image quality.

The generating of the data based on the similarity comparison may include: calculating a similarity between the text feature vectors and the image feature vectors; and based on the similarity, generating the data for each attribute corresponding to the antonym pairs.

The VLM may model a correlation between the target image and text corresponding to the target image onto an embedding space shared between the target image and the text.

The image-quality attribute may include brightness, colorfulness, sharpness, or noise of the target image.

The training of the target encoder may include: generating output values by applying the target image to the target encoder; and training the target encoder such that the target encoder simulates the correlation modeled by the VLM, the training based on a difference in values between the data and the output values, wherein the data includes pieces, and wherein the number of output values is the same as the number of pieces of the data.

The training of the target encoder may configure the target encoder to predict image-quality assessment scores for respective words related to the image quality by using a loss based on the data.

The target encoder may include a convolutional neural network (CNN) and multi-layer perceptron (MLP) heads, each MLP head may include a first layer and a second layer, and the fine-tuning may include: concatenating output features of the first layers, the output features not produced by the second layers; and fine-tuning the target encoder to predict an assessment result of the image quality by re-training a feature fusion network by an image-quality assessment data set in which a ground truth mean opinion score (MOS) value exists, the re-training may be performed by applying the concatenated output features to the feature fusion network.

The image-quality assessment data set may be generated based on tuning parameters in an image signal processing (ISP) pipeline configured to convert raw data of a camera into a red, green, and blue (RGB) image.

The method may further include: extracting a feature of a text script inputted by a user by using a text encoder of the VLM; based on the feature of the text script, predicting weights of features respectively corresponding to classes generated by the fine-tuned target encoder; and outputting an assessment result of the image quality, in which an intention of the user is reflected, by using the predicted weights.

In another general aspect, a method of image-quality assessment is performed by one or more processors and includes: outputting an assessment score of image quality corresponding to an input image by inputting the input image to a predetermined target encoder, wherein the target encoder is trained to simulate a visual-language model (VLM) based on data obtained by applying, to the VLM, a text prompt corresponding to representation related to image quality of an image.

The method may further include: receiving a text script inputted by a user; extracting a feature from the text script by applying the text script to a pre-trained text encoder; based on the extracted feature, predicting weights of features respectively corresponding to classes; and outputting an assessment score of the image quality, in which an intention of the user is reflected, by using the predicted weights.

In another general aspect, an apparatus for image-quality assessment includes: an image sensor configured to capture an input image; a memory configured to store a pre-trained target encoder; and one or more processors configured to: calculate an assessment score of image quality corresponding to the input image by inputting the input image to the pre-trained target encoder, wherein the target encoder is pre-trained to simulate a visual-language model (VLM) based on data obtained by applying, to the VLM, a text prompt corresponding to representation related to image quality of an image.

Other features and aspects will be apparent from the following detailed description, the drawings, and the claims.

### BRIEF DESCRIPTION OF THE DRAWINGS

FIG. 1A is shows an image-quality assessment (IQA) method according to one or more embodiments.

FIG. 1B shows structure of an example IQA apparatus according to one or more embodiments.

FIG. 2 shows an example method of determining a text prompt according to one or more embodiments.

FIG. 3 shows a method of generating data according to one or more embodiments.

FIG. 4 shows an example method of training a target encoder according to one or more embodiments.

FIG. 5 shows an example method of fine-tuning a trained target encoder according to one or more embodiments.

FIG. 6 shows an example method of building an IQA data set according to one or more embodiments.

FIG. 7 shows an example method of predicting image-quality scores for respective words related to an image-quality attribute, according to one or more embodiments.

FIG. 8 shows an example method of outputting an IQA result reflecting an intention of a user as expressed in a text script inputted by the user, according to one or more embodiments.

FIG. 9 shows an IQA method according to one or more embodiments.

FIG. 10 shows an IQA apparatus according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

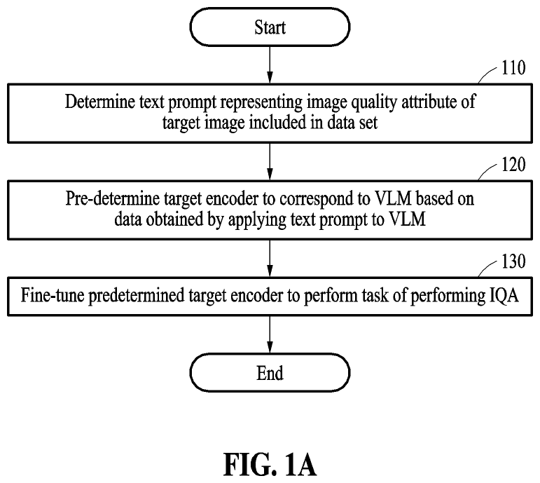

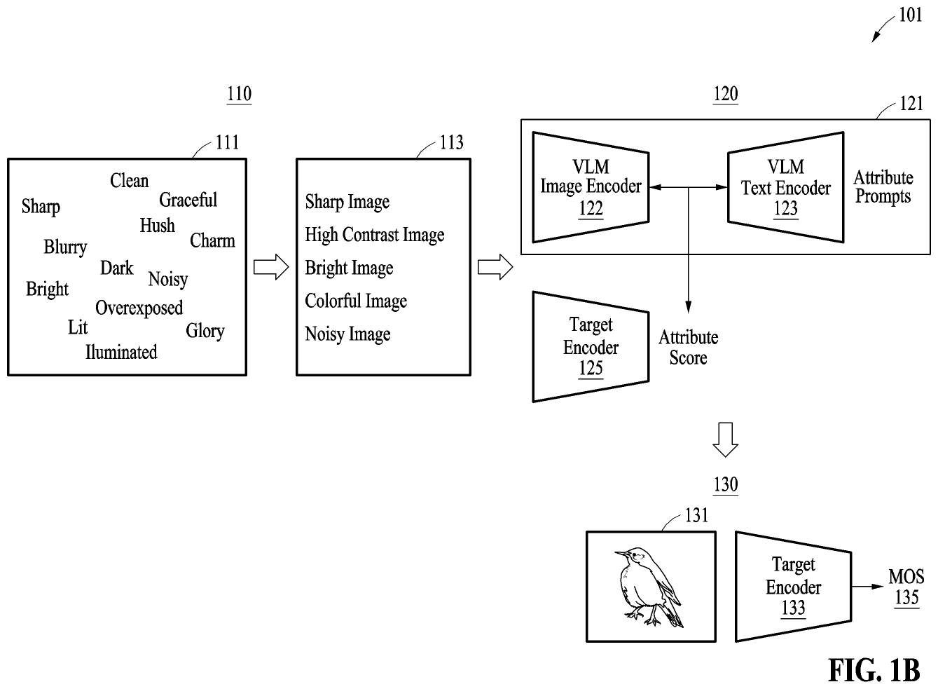

FIG. 1A shows an image-quality assessment (IQA) method according to one or more embodiments. FIG. 1B shows structure of an IQA apparatus according to one or more embodiments.

Referring to FIGS. 1A and 1B, an IQA apparatus in one or more embodiments may perform image-quality assessment by fine-tuning a target encoder 125 through operations 110 to 130. An IQA of an image may be a prediction of human-perceived quality and/or a numerical value of an aesthetic quality of an image as perceived by a person when viewing the image. An IQA may also be referred to as a picture quality assessment.

The notion of image quality may be regarded as a set of complex and abstract features of an image, quantification of which may be elusive. Typically, ground truth information about image quality may be numerical values, such as a mean opinion score (MOS) value. Reducing image quality to such simple metrics may make them less useful for extracting significant features related to image quality.

In operation 110, an IQA apparatus may determine a text prompt 113 that represents an image attribute of a target image included in a data set. The IQA apparatus may train the text prompt 113 by using a visual-language model (VLM) 121 that functions as a classifier to infer data. In this case, the data may be unlabeled data. Hereinafter, the term “data”, depending on context, indicates unlabeled data. For example, a pseudo-label may be data. The IQA apparatus may use the VLM 121 to extract, from arbitrary images (unlabeled data), features based on keywords that are related to IQA, which are unlabeled data. An extracted feature may be referred to as a pseudo label.

The text prompt 113 may correspond to one representation to be learned by a network (e.g., the target encoder 125). A text-based prompt (e.g., the text prompt 113) may be easily interpreted. Incidentally, a prompt, in machine learning, is usually a piece of information, such as text, that provides instruction or guidance to a model on performing an inference, and is often inputted in combination with an input data that is the direct target of inference by the model. As noted, a text-based prompt may be readily interpreted, however, it may be difficult to directly determine which text (e.g., word/phrase) in a text prompt is most highly correlated to a particular image-quality attribute of the target image. Therefore, the text prompt 113 to be used for pre-training may be determined using varying degradations of the target image. In this case, the text prompt 113 may correspond to an interpretable representation element (e.g., a keyword or text) to be learned by the VLM 121 with respect to the target image. For example, the image-quality attribute may include brightness, colorfulness, sharpness, and/or noise of the target image, as non-limiting examples.

The IQA apparatus may analyze a correlation between the image quality of the target image and a group 111 of words related to the target image. The IQA apparatus may select the text prompt 113 corresponding to the image-quality attribute of the target image based on a result of correlation analysis.

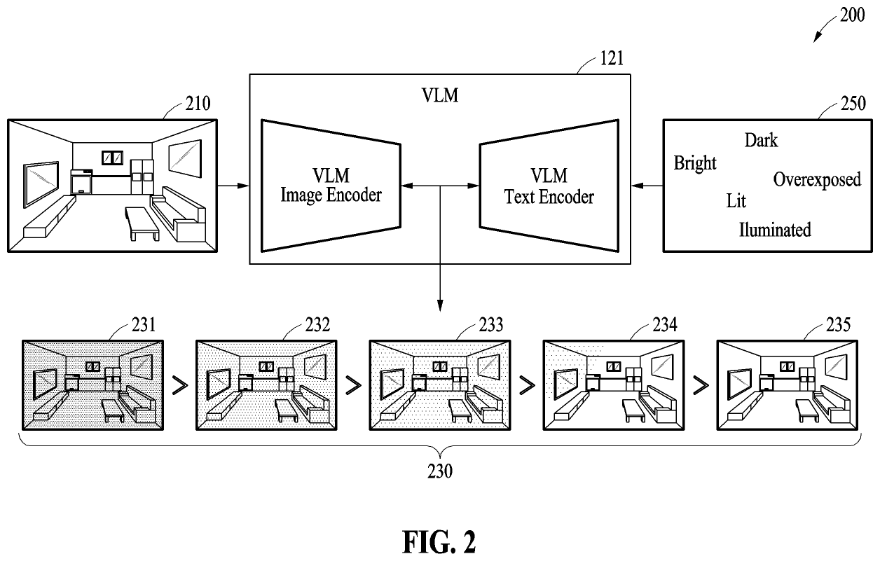

Operation 110 may involve selecting or determining the text prompt 113, which is a keyword(s) or a word(s) evaluated to have a high correlation when assessing the image-quality of the target image. The process in which the IQA apparatus determines the text prompt 113 corresponding to the image-quality attribute of the target image (by analyzing the correlation) is further described with reference to FIG. 2.

In operation 120, the IQA apparatus may pre-train the target encoder 125 to simulate the VLM 121 based on the data obtained by applying the text prompt 113 determined in operation 110 to the VLM 121 (“pre-training” is used to distinguish from later fine-tuning of the target encoder 125). The VLM 121 may model correlation between a target image and text (e.g., the text prompt 113) corresponding to the target image in an embedding space shared between the target image and the text. More specifically, when an image or text is input to the VLM 121, the VLM 121 may represent each element of the image or text as a feature of an embedding space shared between the image and the text.

After the VLM 121 sets the text prompt 113 to be a classifier using a feature in which the image and the text are represented as features of the embedding space, the VLM 121 may perform zero-shot inference that predicts an IQA score, which may be done in a method that calculates, without training, a similarity (e.g., a cosine similarity) between the feature represented in the embedding space and the feature of the target image. The zero-shot inference may involve performing a task in zero-shot, wherein the task may be text-to-image generation. In this case, the zero-shot may involve performing a task that a neural network model does not learn during a training process. Here, a neural network model performing a task that the neural network model does not learn during the training process means that the model is trained to perform a task X and it performs a task Y by understanding an example of task Y. A reason for causing the neural network model to perform a task that the neural network model does not learn during the training process may be to allow the neural network model to appropriately learn semantic information during the training process. For example, the neural network model may learn semantic information, for example, training a voice model to understand elements constituting voice, training a natural language model to understand a language, and training an image model to understand an image. When the neural network model is trained to understand generalized knowledge of each domain, the neural network model may adapt to various tasks belonging to each domain. In one embodiment, zero-shot inference may be performed on a specific task by leveraging the VLM 121's performance of prediction without training. The IQA apparatus may pre-train the target encoder 125 using data generated based on the text prompt 113 related to image quality and using the VLM 121.

In addition, in one embodiment, transfer learning that uses a neural network model (that is trained for a specific task) by additionally training for another task may be used through pre-training and fine-tuning processes to improve the learning performance. Through the transfer learning, the IQA apparatus may, for example, be trained to predict an IQA score for an image-quality attribute of an image as the target encoder 125 simulates (mimics) the VLM 121 in a method similar to knowledge distillation.

When the IQA apparatus quantifies a correlation between the target image and a keyword corresponding to the text prompt 113, the IQA apparatus may generate a target numerical value as data and may pre-train the target encoder 125 based on the data.

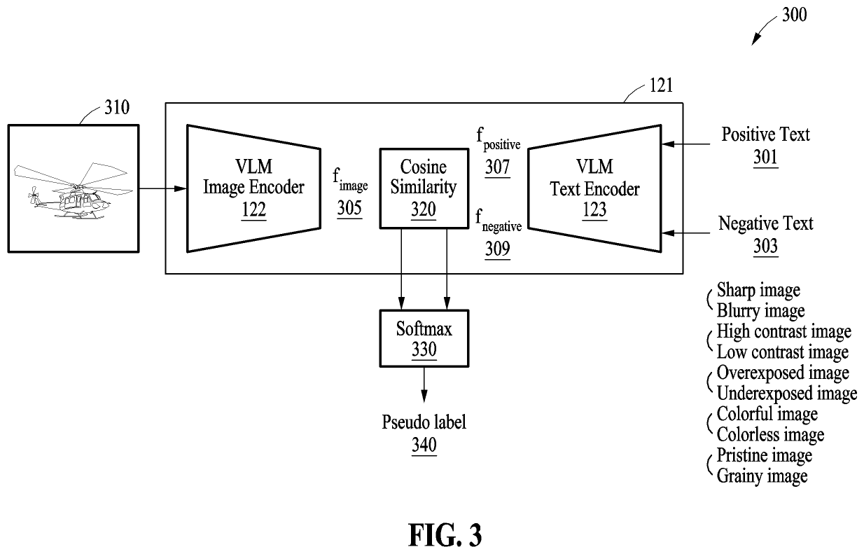

The IQA apparatus may generate data representing a degree of the correlation corresponding to image-quality attributes of the target image by comparing the correlation between the keyword and the image-quality attribute of the target image. A method of generating data by the IQA apparatus is further described with reference to FIG. 3.

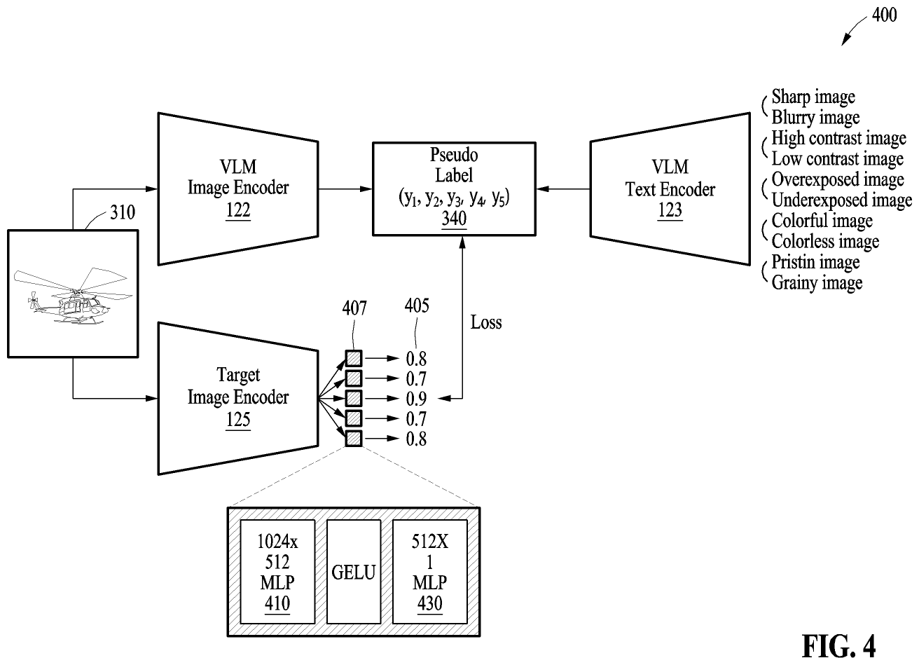

The IQA apparatus may generate data using the VLM 121 and the text prompt 113 and may pre-train the target encoder 125 for a large volume of unlabeled data sets using the data. The target encoder 125 may be an image encoder, for example. In this case, the VLM 121 may include (i) an image encoder 122 configured to represent the target image as an image feature vector of an embedding space shared between the target image and the text prompt 113, and (ii) a text encoder 123 configured to represent the text prompt 113 as text feature vectors of the embedding space. The method of pre-training the target encoder 125 by the IQA apparatus and a structure of the target encoder 125 are further described with reference to FIG. 4.

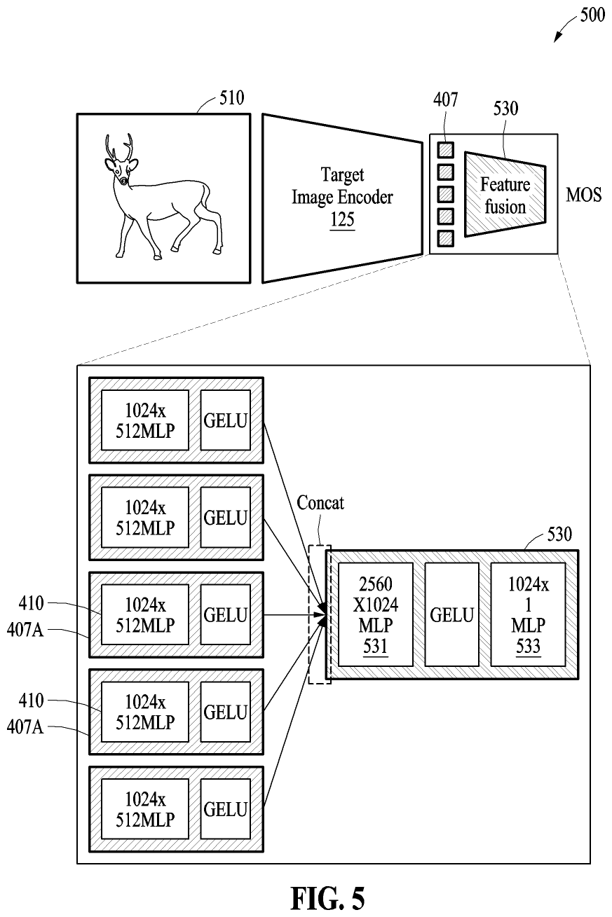

In operation 130, the IQA apparatus may fine-tune the target encoder 125 (which has been pre-trained in operation 120) to perform a task of performing IQA. Operation 130 may involve the IQA apparatus fine-tuning the predetermined target encoder 125 based on a DB (e.g., an IQA data set) having a correlation with an image of the targeted image quality. The IQA apparatus may perform a task of performing IQA on a test image 131 by fine-tuning the target encoder 125 with the test image 131 included in an IQA data set. In this case, the target encoder 133 fine-tuned in operation 130 may calculate an IQA score 135 as a result of IQA. For example, the IQA score 135 may correspond to a mean opinion score (MOS) value obtained by averaging numerical values obtained as persons watched and assessed an image (e.g., the test image 131), as a non-limiting example. The method of fine-tuning the predetermined encoder 125 by the IQA apparatus is further described with reference to FIG. 5.

Depending on implementation, the IQA apparatus may output the IQA result based on an actual natural language rather than the IQA score 135. Based on the IQA score 135 for each item, the IQA apparatus may, for example, generate a text description in the perspective of IQA, such as, “because the tone of a facial color of a girl in an image is quite dark and the clothes and skin are excessively over-sharpened, the overall image quality score is quite deducted in terms of brightness and sharpening”.

The training method may easily extend to any task related to image quality and may provide, by using an interpretable element that is the text prompt 113, various interpretation results in an aspect of assessment of the image quality, such as a correlation between the MOS value 135 and a specific image-quality attribute output by the VLM 121 and/or a correlation between a specific data set and an image-quality attribute.

FIG. 2 shows an example method of determining a text prompt according to one or more embodiments. Referring to FIG. 2, diagram 200 shows examples of data corresponding to steps performed by an IQA apparatus in determining a text prompt (e.g., the text prompt 113 of FIG. 1B) based on degraded images 230.

The IQA apparatus may use the VLM 121 to analyze a correlation between image quality of a target image 210 and a group 250 of words related to the target image 210. In this case, the VLM 121 may be a neural network pre-trained to provide a numerical interpretation with respect to similarity between the text prompt and the target image. Determination of the text prompt may affect the IQA performance because the text prompt is highly correlated to IQA among words related to IQA.

The IQA apparatus may select the group 250 of words related to image-quality degradation of the target image 210. The IQA apparatus may apply an artificial degradation effect to the target image 210 (without needing a separate label of the target image 210) by leveraging the fact that degradation changes the image quality in a single direction (e.g., a monotonically increasing or decreasing) and may determine the text prompt by using the degraded images 230 as labels.

More specifically, the IQA apparatus may, for example, select the group 250 of words related to image-quality degradation of the target image 210 using a large language model (LLM). The LLM may include, for example, ChatGPT, a large language model Meta artificial intelligence (LLaMA), language model for dialogue applications (LaMDA), Imagen, Alpaca, and Vicuna, to name some non-limiting examples. For example, the group 250 of words related to image-quality degradation may include first texts (words/phrases) of a positive attribute and second texts (words/phrases) of a negative attribute. In the case of the non-limiting example shown in FIG. 2, the positive attribute may correspond to a positive expression, such as “bright”, “lit”, and “sharp”, and the negative attribute may correspond to a negative expression, such as “dark”, “dim”, “dull”, and “blurry”.

For example, the IQA apparatus may generate the degraded images 230 by sequentially applying, to the target image, an image degradation effect corresponding to the group 250 of words, and may do so by varying the intensity of image degradation effect. The intensity of the effect may be increased or decreased monotonically. The image degradation effect may include, as non-limiting examples, bright, overexposed, lit, illuminated, dark, dim, dull, sharp, blur, and noise.

The IQA apparatus may select the group 250 of words by searching for the text most appropriate to an IQA attribute based on an ordered pair of the degraded images 230 obtained by sequentially applying the image degradation effect to the target image 210.

The IQA apparatus may calculate similarities between the degraded images 230 and words included in the group 250 of words. For example, the IQA apparatus may calculate a similarity to a target word (e.g., the text prompt) using zero-shot inference based on the VLM 121.

The IQA apparatus may analyze a correlation between the similarity and the intensity of image-quality degradation. Based on an analysis result of the correlation, the IQA apparatus may select a word representing the greatest correlation with the intensity of image-quality degradation from the words included in the group 250 or a text prompt corresponding to an image-quality attribute of the target image 210 from an antonym pair.

For example, it may assume that the IQA apparatus calculates similarity to “bright” among words included in the group 250. In this case, the IQA apparatus may calculate the similarity between the word “bright” and each of five degraded images 230 to which the effect of image-quality degradation is incrementally applied. The similarity values may sequentially increase. For example, the similarity between a degraded images 231, 232, 233, 234, and 235 and the word “bright” may be, respectively 0.3, 0.45, 0.6, 0.75, and 0.9. In this case, ranks of the five degraded images 230 monotonically increase from rank 1 to rank 5 (“rank” referring to the order/rank of the corresponding degraded image). As described above, when a monotonic increase rate of ranks shows a linear increase (which also requires that the similarity values increase linearly), the IQA apparatus may calculate the correlation as “1”. In other words, when the similarity values, per the order of their degraded images, monotonically increase (and possibly also linearly), then the correlation may be set to be “1”.

In addition, the IQA apparatus may calculate similarity between the word “overexposed” and the five degraded images 230 to which the effect of image-quality degradation is applied. The similarity may increase. For example, the word “overexposed” and the degraded images 231, 232, 233, 234, and 235 may be, respectively 0.2, 0.4, 0.3, 0.75, and 0.6. In this example, ranks of the five degraded images 230 may be 1, 3, 2, 5, and 4, respectively. As described above, when the ranks do not monotonically increase, the IQA apparatus may calculate the correlation as a value that is less than “1”.

In this example, the word “bright”, based on having great similarity and high rank, may be determined to be the text prompt corresponding to the target image 210 based on whether the ranks corresponding to the order of similarity values are sequential, e.g., monotonically increasing or decreasing, as well as the similarities between the word and the five degraded images 230.

FIG. 3 shows example method of generating data according to one or more embodiments. Referring to FIG. 3, diagram 300 shows a process in which an IQA apparatus generates data (e.g., a pseudo label 340) using the VLM 121.

The IQA apparatus may generate a pseudo label 340 by applying, to the VLM 121, a text prompt (e.g., a first text prompt 301 of a positive attribute and a second text prompt 303 of a negative attribute) determined as described with reference to FIG. 2.

The IQA apparatus may generate the pseudo label 340, which represents a degree of correlations corresponding to image-quality attributes of a target image 310, by comparing correlations between the image-quality attribute of the target image 310 and the text prompts 301 and 303. The text prompt 301 may have N positive attributes related to image quality and the second text prompt 303 may have N negative attributes related to image quality.

The IQA apparatus may obtain an image feature vector (e.g., f_{image} 305) by projecting the target image 310 onto an embedding space using the image encoder 122 of the VLM 121.

The IQA apparatus may obtain text feature vectors (e.g., fₚₒₛᵢₜᵢᵥₑ 307 and f_{negative} 309) by freezing a parameter of the VLM 121 (i.e., not updating/training the VML 121) and projecting features of the text prompts 301 and 303 onto the embedding space of the VLM 121 using the text encoder 123 of the VLM 121. More specifically, after the IQA apparatus freezes a parameter of the VLM 121, the IQA apparatus may obtain the text feature vectors 307 and 309 by projecting the first text prompt 301 and the second text prompt 303 onto the embedding space in the form of one-on-one antonym pairs, wherein the first text prompt 301 may function as a classifier. The one-on-one antonym pair of the first text prompt 301 of the positive attribute and the second text prompt 303 of the negative attribute may be, for example, (Sharp image, Blurry image), (High contrast image, Low contrast image), (Overexposed image, Underexposed image), (Colorful image, Colorless image), and (Pristine Image, Grainy Image), but the example is not limited thereto.

The IQA apparatus may generate the pseudo label 340 based on a similarity comparison result between the image feature vector 305 and the text feature vectors 307 and 309. The IQA apparatus may calculate a similarity (e.g., a cosine similarity 320) between the image feature vector 305 and the text feature vectors 307 and 309. The IQA apparatus may generate the pseudo label 340 for each attribute of the image-quality corresponding to the antonym pair including the first text prompts 301 and the second text prompts 303, based on the similarity 320. The IQA apparatus may set a numerical value obtained by normalizing the similarity 320 and then passing it through a softmax layer 330 which outputs the pseudo label 340 of a corresponding image-quality attribute of the target image 310. The IQA apparatus may perform pre-training on a large volume of unlabeled data sets based on the pseudo label 340 generating process. A method of pre-training a target encoder by data (e.g., the pseudo label 340) is described with reference to FIG. 4.

FIG. 4 shows an example method of pre-training a target encoder, according to one or more embodiments. Referring to FIG. 4, diagram 400 shows pre-training based on the VLM 121 and its image encoder 122 and the text encoder 123. The pre-determination process of FIG. 4 may be simultaneously performed with the process of generating the data described with reference to FIG. 3. The target image encoder 125 may include a convolutional neural network (CNN)-based backbone network. An output path of the target image encoder 125 include N multi-layer perceptron (MLP) heads 407. An output of the CNN-backed backbone network may be connected to each of the N MLP heads 407. Each MLP head 407 may include an input layer 410, a GELU (activation function), and an output layer 430.

While generating the data, the IQA apparatus may calculate N output values 405 by inputting the target image 310 to the target encoder 125, which is a network to be trained. The target encoder 125 infers (specifically, the CNN) an output from the input image 310 (e.g., a feature vector/map). The output is inputted to each of the N multi-layer perceptron (MLP) heads 407, which may generate the N (five) respective outputs 405, for example, 0.8, 0.7, 0.9, 0.7, 0.8 (predicted probabilities/scores). As noted above, the value of 5 for N is a non-limiting example. The structure of the target encoder 125 may vary, however, the number of outputs 405 output by the target encoder 125 (by its MLP heads 407) should be the same as the number of pseudo labels 340 (N). That is, the number of MLP heads 407 should be N.

Each MLP head's input layer 410 may, for example, output 512 features, such as 1024×512. Each MLP head's output layer 430 may map the 512 output features to one output value 405, i.e., a score/probability.

The IQA apparatus may train the target encoder 125 by targeting the pseudo label 340 generated by the VLM 121 (of which a parameter is frozen). The pseudo label 340 may, for example, correspond to five numbers, such as (y1, y2, y3, y4, y5). During this process, since uncertainty exists in the pseudo label 340, the IQA apparatus may train the target encoder 125 using a rank-based loss that may robustly handle the uncertainty. Rank-based loss is described next.

The IQA apparatus may train the target encoder 125 to simulate a correlation (e.g., a correlation map and a correlation score) modeled by the VLM 121 based on differences between values of the pseudo label 340 and the respective outputs 405. The number N of outputs 405 may be the same as the number of pseudo labels 340.

Although a range covered by the VLM 121 is significantly large, in some implementations the target encoder 125 may learn a correlation with a keyword related to IQA predicted by the VLM 121. The correlation may be expressed by, for example, a Pearson linear correlation coefficient (PLCC) representing how strong the linearity between two variables is and a Spearman rank-order correlation coefficient (SROCC) assessing monotonicity, as a non-limiting example.

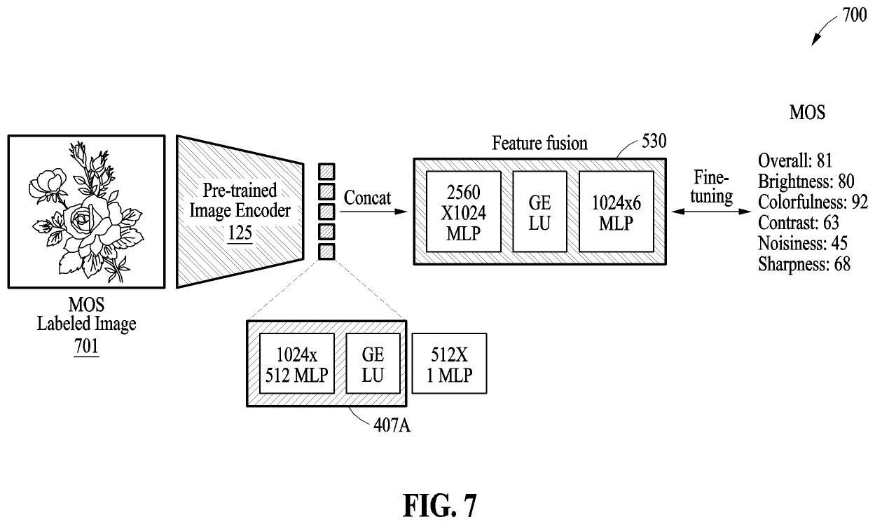

Depending on an embodiment, the IQA apparatus may pre-train the target encoder 125 such that the target encoder 125 may become able to predict an IQA score for each word related to a corresponding image-quality attribute, much like the VLM 121. The pre-training may be performed using a loss (e.g., difference between values of the pseudo label 340 and the respective outputs 405) based on the pseudo label 340. The training may involve backpropagating the loss through the target encoder 125. The method in which the IQA apparatus pre-trains the target encoder 125 to be able to predict an IQA score for each word is further described with reference to FIG. 7.

FIG. 5 shows an example method of fine-tuning the trained target encoder 125, according to one or more embodiments. Referring to FIG. 5, diagram 500 shows a process of fine-tuning the trained target encoder 125 based on a task.

After the pre-training is performed with the method described above, the IQA apparatus may fine-tune the target encoder 125 based on processing training samples in an IQA data set 510 in which a ground truth mean opinion score (MOS) value exists (a sample may be a training image paired with a ground truth MOS). In this case, the target encoder 125 may further include a feature-fusion network 530 for fine-tuning the target encoder 125. The feature-fusion network 530 may fuse features extracted from a training image (from IQA data set 510 and having a ground truth MOS) by the target image encoder 125 and by reduced MLP heads 407A (described next). This may be done in order to fine-tune a representation space of the MLP heads 407 (e.g., a space of the 1024×512 MLP input layers 410) that have been pre-trained to extract a feature of words related to an image-quality attribute in the pre-training process. The feature fusion network 530 may include an activation function, such as a Gaussian error linear unit (GELU).

To finally use only the representation space of the existing N MLP heads 407, the IQA apparatus may remove/bypass the output layers 430 of the respective MLP heads 407. The reduced MLP heads 407A shown in FIG. 5 are the MLP heads 407, but without the output layers 430.

The IQA apparatus may concatenate output features of the respective reduced MLP heads 407A and apply the concatenated output features to the feature fusion network 530. An input layer 531 of the feature fusion network 530 receives the concatenated features and an output layer 533 of the feature fusion network 533 outputs a predicted MOS.

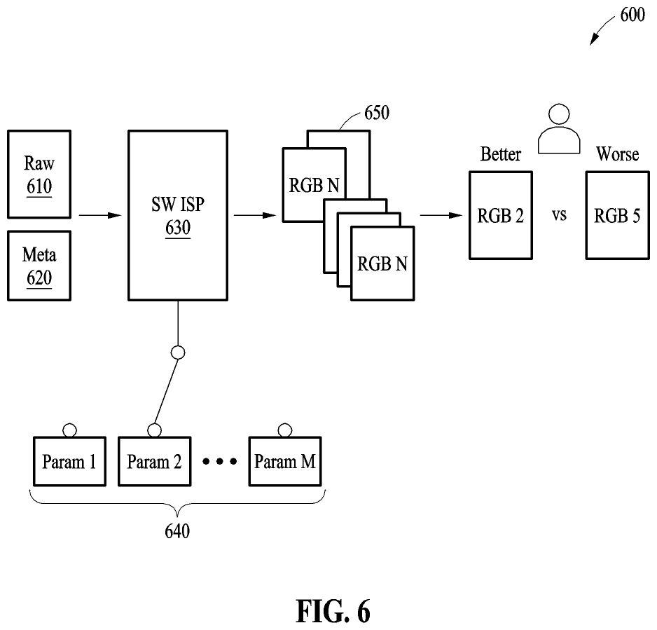

The IQA apparatus may fine-tune the target encoder 125 to predict an assessment result of image quality by re-training the feature fusion network 530 based on the IQA data set 510 having a ground truth MOS value. The IQA apparatus may fine-tune the target encoder 125 by backpropagating an L1 loss, which is a loss between a ground truth MOS value corresponding to each data set and an output value of the feature fusion network 530. The IQA data set 510 may be generated by a combination of tuning parameters in an image signal processing (ISP) pipeline that converts the raw data of a camera into an RGB image. The method of building an IQA data set is described with reference to FIG. 6.

FIG. 6 shows a method of building an IQA data set according to one or more embodiments. Referring to FIG. 6, diagram 600 shows a process of building an IQA database from a perspective of ISP preference.

As described with reference to FIG. 5, a fine-tuning process, may use a data set (e.g., the IQA data set 510) in which a ground truth MOS value exists. To secure the data set, a quantitative standard may be obtained to determine optimal tuning parameters 640 (e.g., Param 1, Param 2, . . . , and Param M) in an ISP pipeline 630 that converts raw data 610 (e.g., a raw image) of a camera and metadata 620 into RGB images 650. The ISP pipeline 630 may be, for example, implemented as software (SW) (in the form of processor-executable instructions) and/or hardware.

For example, the RGB images 650 may be sRGB images following an international standard. The raw data 610 may be, for example, an unprocessed raw image. The metadata 620 may be about the raw data 610 and/or about the camera and may include, for example: a manufacturer of a camera capturing the raw data 610, a camera model, an editor, a date of capturing the photo, a date of modifying the photo, the size of the photo, an exposure time, a lens focal length, an aperture opening value, the use of flash, and/or location information.

The IQA apparatus may generate N RGB images 650 (N is a natural number greater than 0) based on a combination of various ISP tuning parameters 640 with respect to the raw data 610 by considering various scenes and objects and may assess subjective image-quality preferences of the generated RGB images 650. By considering that an image-quality recognition attribute may vary for different the raw images (e.g., the raw data 610), the IQA apparatus may assess the image quality of the RGB images 650 by dividing the tuning parameters 640 into a restoration aspect and an enhancement aspect. A tuning parameter used for restoration may be, for example, texture, sharpening, noise reduction, and color noise reduction. In addition, a tuning parameter used for enhancement may be items, for example, exposure, contrast, saturation, and tone-mapping.

The IQA apparatus may generate RGB images 650 by sampling each item (raw image) at N levels. In other words, the IQA apparatus may generate, from one raw image (raw data 610), a number of RGB images 650 that is (the number of the tuning parameters 640)\hat{ }(N).

To increase reliability, rather than directly asking a subject (user) for a human-assessed quality score, the IQA apparatus may obtain a quality score by performing IQA to calculate a score, which may be done by combining (i) pairwise comparison (e.g., each unique pair of RGB images 650) with (ii) the Elo rating system. The IQA apparatus may use the Swiss system for the pairwise comparison. In addition, for the assessment in the aspect of enhancement, the IQA apparatus may use the raw data 610 collected by continent (or by region of the continent) because a regional characteristic may exist.

In one embodiment, the size of a data set (e.g., the IQA data set 510) may be increased without limit by using unsupervised learning. As the size of the IQA data set 510 (used for training of the target encoder) increases, the performance of the target encoder may increase.

The IQA apparatus may obtain/generate the IQA data set 510 by providing an ISP tuning preference that, when set, causes IQA to be performed on the generated RGB images 650 by varying a combination of the tuning parameters 640 in the ISP pipeline 630.

FIG. 7 shows an example method of predicting an image-quality score for each word related to an image-quality attribute, according to one or more embodiments. Referring to FIG. 7, diagram 700 shows a method using the target encoder 125 to predict an IQA score for each word related to an image-quality attribute during a training process.

The trained target encoder 125 may learn expressions related to image quality to predict an IQA score. Therefore, the target encoder 125 may predict not only one MOS value corresponding to an input image but also the image quality as detailed through multiple image-quality attributes, such as brightness and sharpness. In this case, a database providing a score for each image-quality attribute may exist. If there are six IQA image-quality attributes, for example, overall, brightness, colorfulness, contrast, noisiness, and sharpness, the IQA apparatus may train the target encoder 125 to output, through the feature fusion network 530, an IQA score for each image-quality attribute.

As described above, when a ground truth label having ground truth MOS values for the respective image-quality attributes exists (e.g., 81, 80, 92, 63, 45, and 68), the target encoder 125 may be a model that predicts IQA scores for words respectively related to the image-quality attributes.

The IQA apparatus may train the target encoder 125 such that, like a VLM (but without the considerable overhead thereof), the target encoder 125 may predict IQA scores of the respective image-quality attributes by using a loss based on data.

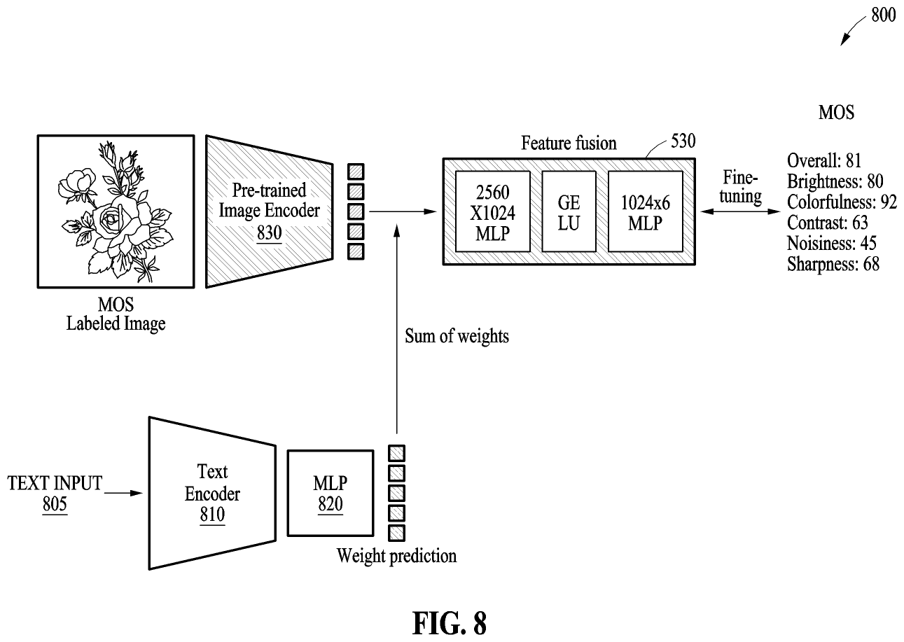

FIG. 8 shows an example method of outputting an IQA result reflecting an intention of a user as expressed in a text script inputted by the user, according to one or more embodiments. Referring to FIG. 8, diagram 800 shows a method of an IQA apparatus, when performing IQA, reflecting a preference of a user based on text 805 inputted by the user.

The IQA apparatus may extract a feature of a text script (text input 805) inputted by a user; the extraction may be performed by a text encoder 810 of a VLM. The text encoder 810 may further include an MLP head 820. The text encoder 810 may not directly select a text prompt.

The IQA apparatus may predict weights of features corresponding to classes generated by a target encoder 830 (e.g., the fine-tuned target encoder 133 of FIG. 1B) that is fine-tuned through the process described above based on the feature of the text script extracted by the text encoder 810. The IQA apparatus may determine which image to assign a greater weight to by the feature of the text script extracted by the text encoder 810.

For the features corresponding to the classes (image-quality attributes) generated by the fine-tuned target encoder 830, the IQA apparatus may predict an MOS value by applying, to the feature fusion network 530, a sum of the weights that are predicted by the text encoder 810 and the MLP 820 to the input of the feature fusion network 530. The IQA apparatus may fine-tune the target encoder 125 according to an L1 loss between (i) the ground truth MOS value and (ii) an output value of the feature fusion network 530 generated based on the MOS-labeled image. To elaborate, N image quality-related features are extracted through the encoder 830. In a feature fusion network 530, the final image quality score is predicted by concatenating and fusion of each extracted N feature. At this time, in a feature fusion network, instead of concatenating and fusion of N features with the same weight, the weight of each feature is differentiated according to the user's intention. At this time, the weight can be applied by generating an attention vector that makes the sum of N become 1 as the concept of attention and multiplying it by N features. The MLP head 820 may need to learn so that it can generate the weight of N image quality-related features according to the intention of the user's input text. Incidentally, at this time, the learning data must have data in which the image quality evaluation score and the text input indicating the user's image quality evaluation intention exist as a pair.

The correlation between the text script and the image quality of an image described above may be used for not only training but also for providing an IQA result reflecting the user's preference based on text during an inference process (e.g., IQA) using a trained target encoder.

The IQA apparatus may receive an assessment command and/or an assessment item that a user desires to focus on as a text script, and the IQA apparatus may provide personalized IQA based on an intention of the user. In this case, the text script input by the user for personalized IQA may be, for example, “assess from the perspective of emotional photos for Instagram,” or “assess based on North American image-quality preferences,” but the example is not limited thereto.

To summarize, the IQA apparatus may extract a feature of text and/or a text script inputted by a user using a predetermined text encoder and may reflect an intention of the user in the final IQA by predicting weights of features of respective items generated by an image encoder based on the feature of the text script.

The trained text encoder 810 and the MLP head 820, through the process described above, may be used for IQA that reflects the user's preference in an inference process.

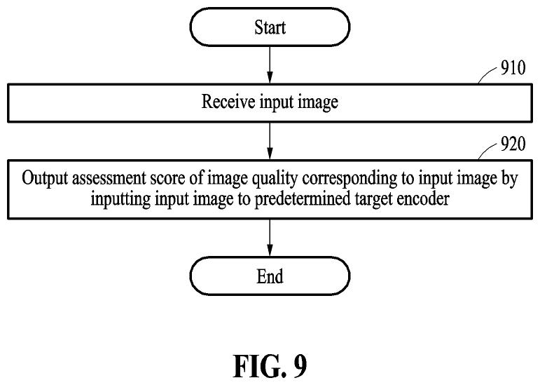

FIG. 9 shows an IQA method according to one or more embodiments. Referring to FIG. 9, an IQA apparatus may output an assessment score of image quality through operations 910 and 920.

In operation 910, the IQA apparatus may receive an input image. The input image may be, for example, an RGB image captured by a camera or an image sensor, as a non-limiting example.

In operation 920, the IQA apparatus may output an assessment score (IQA score) of the image quality corresponding to the input image by inputting the input image to a trained target encoder. The target encoder may be a neural network configured, by previous training, to simulate the VLM 121 based on data, the data obtained by applying a text prompt (corresponding to representation related to image quality) to the VLM 121.

In addition, the IQA apparatus may receive a text script input by a user. The IQA apparatus may extract a feature from text script by applying the text script to the pre-trained text encoder 123. The IQA apparatus may predict weights of features respectively corresponding to classes based on the extracted feature. The IQA apparatus may use the predicted weight to output an assessment score of the image quality that reflects an intention of the user.

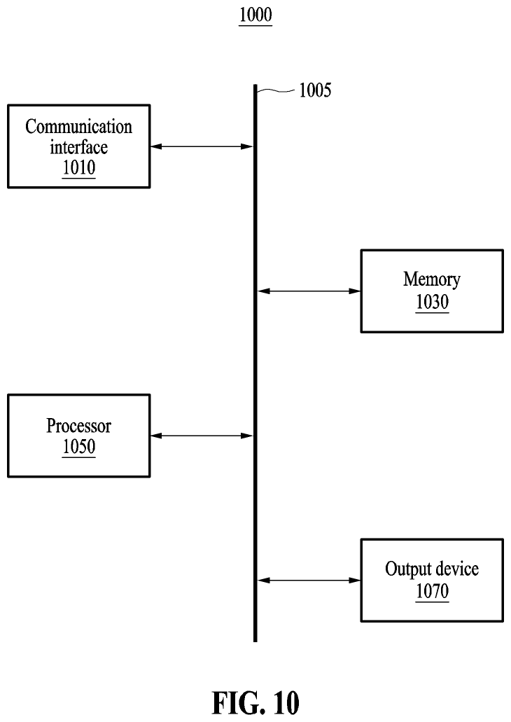

FIG. 10 shows an IQA apparatus according to one or more embodiments. Referring to FIG. 10, an IQA apparatus 1000 may include a communication interface 1010, a memory 1030, a processor 1050, and/or an output device 1070. The communication interface 1010, the memory 1030, the processor 1050, and/or the output device 1070 may be connected to each other via a communication bus 1005. The processor 1050 may be a single processor, or a combination or processors (described below).

The communication interface 1010 may receive an input image. The input image may be, for example, an image captured by a capturing device including a mono camera, a vision sensor, an image sensor, an infrared sensor, or a device for performing a similar function thereto.

The memory 1030 may store a predetermined target encoder. In this case, the target encoder may be a predetermined neural network configured to simulate a VLM based on data obtained by applying a text prompt corresponding to representation related to image quality to the VLM. Here, simulate refers to providing inferences similar/approximate to what the VLM would infer from the same respective inputs.

In addition, the memory 1030 may store various pieces of information generated during the processing of the processor 1050 described above. In addition, the memory 1030 may store a variety of data and programs (i.e., instructions). The memory 1030 may include volatile memory or non-volatile memory. The memory 1030 may include a large-capacity storage medium such as a hard disk to store a variety of data.

The processor 1050 may calculate an assessment score of image quality corresponding to an input image by inputting the input image received by the communication interface 1010 to the target encoder stored in the memory 1030.

The output device 1070 may output the assessment score of the image quality calculated by the processor 1050. For example, the output device 1070 may be an output interface or a display device. For example, when the output device 1070 is a display, the output device 1070 may display the assessment score calculated by the processor 1050 on a screen in response to the input image.

In addition, the processor 1050 may perform the methods described with reference to FIGS. 1 to 9 and an algorithm corresponding to the methods. The algorithm may be, for example, an algorithm for performing unsupervised quality-aware pre-training for an unlabeled data set by using information related to IQA that the VLM knows.

The processor 1050 may execute a program and may control the IQA apparatus 1000. Program codes to be executed by the processor 1050 may be stored in the memory 1030.

The computing apparatuses, the electronic devices, the processors, the memories, the image sensors, the displays, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method, performed by one or more processors, of image-quality assessment, the method comprising:
accessing a text prompt representing an image-quality attribute of a target image included in a data set;
training a target encoder to correspond to a visual-language model (VLM), the training based on data obtained by applying the text prompt to the VLM; and
fine-tuning the trained target encoder to perform image-quality assessment.

2. The method of claim 1, further comprising determining the text prompt by:
analyzing correlations between words related to the target image and image quality of the target image; and
based on a result of analyzing the correlation, selecting the text prompt corresponding to an image-quality attribute of the target image.

3. The method of claim 2, wherein the analyzing of the correlation comprises:
selecting the words related to image-quality degradation of the target image;
generating degraded images by applying, to the target image, with varying intensities, an effect of the image-quality degradation corresponding to the words;
calculating similarities between the degraded images and the words; and
analyzing correlations between the similarities and the intensities of image-quality degradation effect.

4. The method of claim 3, wherein the selecting of the words comprises selecting the words comprising first texts of a positive attribute related to image-quality degradation of the target image using a large language model (LLM) or second texts of a negative attribute related to the image-quality degradation.

5. The method of claim 2, wherein the determining of the text prompt comprises selecting, from the words, an antonym word-pair having a highest correlation to be in the text prompt, the selecting based on the result of analyzing the correlations.

6. The method of claim 1, wherein the VLM comprises:
an image encoder configured to encode the target image as an image feature vector of an embedding space shared between the target image and the text prompt; and
a text encoder configured to encode the text prompt as a text feature vector of the embedding space.

7. The method of claim 6, wherein the training of the target encoder comprises generating the data showing degrees of correlations corresponding to image-quality attributes of the target image by comparing correlations between the text prompt and an image-quality attribute of the target image.

8. The method of claim 7, wherein the generating of the data comprises:
obtaining image feature vectors by projecting the target image onto the embedding space by using an image encoder of the VLM;
obtaining text feature vectors by projecting the text prompt onto the embedding space by using a text encoder of the VLM; and
generating the data based on a similarity comparison between the text feature vectors and the image feature vectors.

9. The method of claim 8, wherein the text feature vectors are obtained by projecting, onto the embedding space, an antonym pair of a positive attribute related to the image quality and a negative attribute related to the image quality.

10. The method of claim 9, wherein the generating of the data based on the similarity comparison comprises:
calculating a similarity between the text feature vectors and the image feature vectors; and
based on the similarity, generating the data for each attribute corresponding to the antonym pairs.

11. The method of claim 1, wherein the VLM models a correlation between the target image and text corresponding to the target image onto an embedding space shared between the target image and the text.

12. The method of claim 1, wherein the image-quality attribute comprises brightness, colorfulness, sharpness, or noise of the target image.

13. The method of claim 1, wherein the training of the target encoder comprises:
generating output values by applying the target image to the target encoder; and
training the target encoder such that the target encoder simulates the correlation modeled by the VLM, the training based on a difference in values between the data and the output values,
wherein the data comprises pieces, and wherein the number of output values is the same as the number of pieces of the data.

14. The method of claim 1, wherein the training of the target encoder configures the target encoder to predict image-quality assessment scores for respective words related to the image quality by using a loss based on the data.

15. The method of claim 1, wherein the target encoder comprises a convolutional neural network (CNN) and multi-layer perceptron (MLP) heads, each MLP head comprising a first layer and a second layer, and
the fine-tuning comprises:
concatenating output features of the first layers, the output features not produced by the second layers; and
fine-tuning the target encoder to predict an assessment result of the image quality by re-training a feature fusion network by an image-quality assessment data set in which a ground truth mean opinion score (MOS) value exists, the re-training performed by applying the concatenated output features to the feature fusion network.

16. The method of claim 15, wherein the image-quality assessment data set is generated based on tuning parameters in an image signal processing (ISP) pipeline configured to convert raw data of a camera into a red, green, and blue (RGB) image.

17. The method of claim 1, further comprising:
extracting a feature of a text script inputted by a user by using a text encoder of the VLM;
based on the feature of the text script, predicting weights of features respectively corresponding to classes generated by the fine-tuned target encoder; and
outputting an assessment result of the image quality, in which an intention of the user is reflected, by using the predicted weights.

18. A method of image-quality assessment, the method performed by one or more processors and comprising:
outputting an assessment score of image quality corresponding to an input image by inputting the input image to a predetermined target encoder,
wherein the target encoder is trained to simulate a visual-language model (VLM) based on data obtained by applying, to the VLM, a text prompt corresponding to representation related to image quality of an image.

19. The method of claim 18, further comprising:
receiving a text script inputted by a user;
extracting a feature from the text script by applying the text script to a pre-trained text encoder;
based on the extracted feature, predicting weights of features respectively corresponding to classes; and
outputting an assessment score of the image quality, in which an intention of the user is reflected, by using the predicted weights.

20. An apparatus for image-quality assessment, the apparatus comprising:
an image sensor configured to capture an input image;
a memory configured to store a pre-trained target encoder; and
one or more processors configured to:
calculate an assessment score of image quality corresponding to the input image by inputting the input image to the pre-trained target encoder,
wherein the target encoder is pre-trained to simulate a visual-language model (VLM) based on data obtained by applying, to the VLM, a text prompt corresponding to representation related to image quality of an image.
